(19) United States
(12) Patent Application Publication
(10) Pub. No.: US 2017/0373562 A1
(43) Pub. Date: Dec. 28, 2017

(54) Thermodynamic system

(71) Applicant: AQYLON, GARENTREVILLE (FR)

(72) Inventor: Pierre CONVERT, MAISONS-LAFFITTE (FR)

(21) Appl. No.: 15/544,629

(22) PCT Filed: Feb. 11, 2016
(86) PCT No.: PCT/EP2016/052946

§ 371 Date: Jul. 19, 2017

(30) Foreign Application Priority Data
Feb. 11, 2015 (FR) 1551108
Feb. 11, 2015 (FR) 1551112

(51) Int. Cl. H02K 9/20; F01K 7/16; F01D 15/10; H02K 7/18; F01K 19/10

(52) U.S. Cl. CPC H02K 9/20; H02K 7/1823; F01K 19/10; F01D 15/10; F01K 7/16; F05D 2220/31

(57) ABSTRACT

The invention relates to a thermodynamic system (10), notably a system (10) implementing a thermodynamic Rankine cycle, comprising a circulation loop (31-36) for the circulation of a working fluid, said loop (31-36) comprising an energy production means (20), said system (10) also comprising a device for cooling said energy production means (20) and a channel (37, 38) designed to supply said cooling device with working fluid from said loop (31-36) and to return said working fluid into said loop (31-36), said cooling device being designed so as to cool said energy production means (20) by vaporisation of the working fluid inside said production means (20), said working fluid entering said energy production means (20) in the liquid phase.

The invention relates to a thermodynamic system, in particular a system implementing a Rankine cycle.

It is known to provide systems implementing a Rankine cycle in the form of circuits that permit the circulation of a working fluid. When circulated within such circuits, the working fluid changes phase, in particular passes from the gaseous state to the liquid state, and vice versa.

These circuits usually comprise a turbine that is coupled to a generator, in particular an electromagnetic generator. In such circuits, the turbine is driven by the expansion of the working fluid in the gaseous state. The turbine, driven in this manner, provides mechanical energy to the generator which transforms this energy into electrical energy, in particular via a rotating element such as a shaft.

Given the heat produced by the generator, it is recommended to provide a cooling device. However, the known cooling devices are complex and in particular require a dedicated circuit for a cooling fluid.

The present invention has the object of providing simple cooling for the generator of a thermodynamic system, in particular of a system implementing a Rankine cycle.

Thus, the invention relates to a thermodynamic system, in particular a system implementing a Rankine cycle, comprising a circuit for circulation of a working fluid, said circuit comprising an energy production means.

Said system further comprises a device for cooling said energy production means and a branch configured to supply said cooling device with working fluid from said circuit and to return said working fluid to said circuit, said cooling device being configured so as to cool said energy production means by evaporation of said working fluid within said production means, said working fluid entering said energy production means in the liquid phase.

According to the invention, said energy production means comprises a turbine that forms part of said circuit, and an electrical energy generator coupled to said turbine, said turbine being designed to be driven by the expansion of said working fluid in the gas phase, said cooling device being configured to cool said generator, said generator being an electromagnetic generator comprising a stator and a rotor, said cooling device comprising a cavity formed in a body that is designed to form part of said rotor, said cavity being designed to receive the working fluid, said device being designed to create a film of said working fluid in its liquid state, in said cavity, under the effect of a centrifugal force that exists when the rotor is in rotation with respect to said stator, said device being further designed to allow said fluid to be evacuated in its gaseous state to outside the cavity.

The thermodynamic system of the invention comprises a cooling device which uses the working fluid of the system to cool the energy production means of said system. This permits simple cooling of said energy production means since this cooling does not require an external circuit for circulating a cooling fluid.

Furthermore, cooling by means of liquid fluid requires a high flow rate; here, however, it is the enthalpy of the working fluid changing state which is used for cooling the energy production means. This makes it possible to provide, advantageously, a flow rate of the liquid working fluid that remains low, in particular at the inlet to the cooling device for the energy production means.

Furthermore, the working fluid evaporated in this manner can advantageously be released into the thermodynamic system, at any point where said fluid is present as a gas.

According to various embodiments of the invention, which may be considered together or separately:
the working fluid designed to be evaporated in said cooling device is introduced into said energy production means, in particular into said generator, via a valve termed the expansion valve,
the working fluid designed to be evaporated in said cooling device is injected into said energy production means, in particular into said generator, via a nozzle termed the injection nozzle,
said circuit further comprises a condenser,
said condenser is configured to condense the working fluid when it is in the gas phase,
said circuit further comprises a pump,
said pump serves to raise the pressure of said working fluid when it is in the liquid phase,
said pump is positioned downstream of said condenser,
the working fluid designed to be evaporated in the cooling device is bled from the circuit downstream of said pump,
said circuit further comprises a regenerator,
said regenerator is configured to exchange heat energy between said working fluid when it is in the gas phase and said working fluid when it is in the liquid phase,
said regenerator is positioned downstream of said turbine in a part of the circuit that is configured for the working fluid to circulate in the gas phase, and downstream of said pump in a part of the circuit that is configured for the fluid to circulate in the liquid phase,
said circuit further comprises an evaporator,
said evaporator is configured to evaporate the working fluid when it is in the liquid phase,
said evaporator is positioned between said pump and said turbine,
the working fluid evaporated inside said energy production means, in particular inside said generator, by said cooling device is released into the circuit upstream of said condenser,
the system according to the invention further comprises a sealing device that is arranged so as to ensure a seal between said turbine and said generator,
said sealing device is positioned between said turbine and said generator,
said sealing device comprises a packing seal that is configured to prevent said working fluid, when in the gas phase, from flowing from said turbine to said generator,
said cavity comprises a pair of walls that are arranged so as to contain the film of fluid in the liquid state,
said cooling device comprises a means for injecting said fluid in the liquid state at the level of said cavity and a discharge duct,
said means for injecting said fluid in the liquid state at the level of said cavity is on the opposite side of said cavity from the discharge duct,
the rotor comprises a shaft which is formed from said body and on which is mounted an electromagnetic element, said shaft having a main direction of longitudinal extent, termed the main axis,
the electromagnetic element is an electromagnetic winding,
the cavity of the cooling device is positioned between said electromagnetic winding and said shaft,
said cavity extends longitudinally along said electromagnetic winding, in the direction of said main axis,
one side of said cavity is in contact with at least one part of said electromagnetic winding.

The invention will be better understood, and further objects, details, features and advantages thereof will become more clearly apparent during the course of the detailed explanatory description which follows of at least one embodiment of the invention which is given purely by way of illustrative and nonlimiting example, with reference to the following attached schematic drawings:

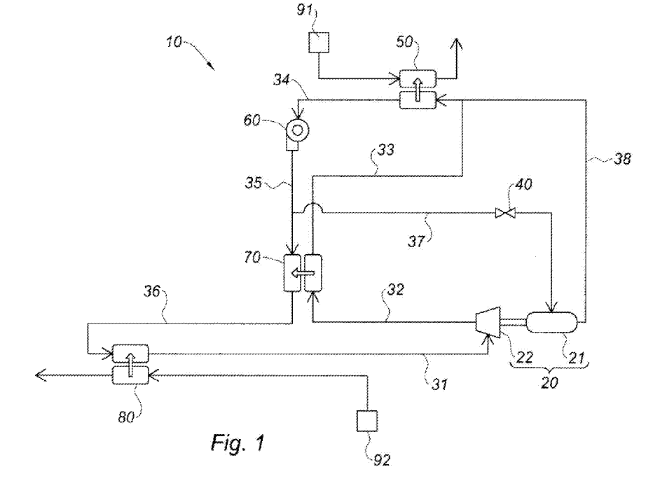

FIG. 1 is a schematic representation of an embodiment of a system according to the invention,

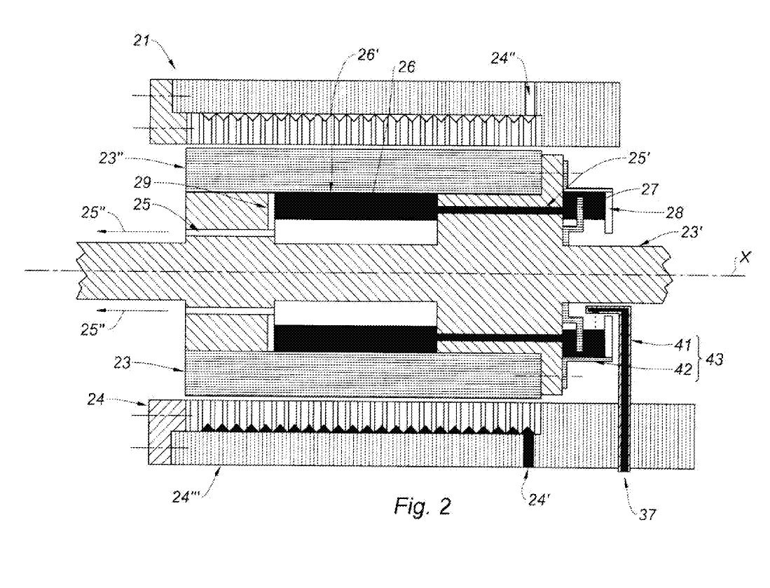

FIG. 2 is a partial schematic section view of an exemplary embodiment of a generator of a system according to the invention.

As shown in FIG. 1, the invention relates to a thermodynamic system 10, in particular a system 10 implementing a Rankine cycle. This system 10 comprises a circuit 31-36 for circulation of a working fluid. Said circuit 31-36 comprises an energy production means 20.

Said energy production means 20 advantageously comprises a turbine 22 and an electrical energy generator 21 coupled to said turbine 22. Said turbine 22 is designed to be driven by the expansion of said working fluid in the gas phase.

According to the invention, said system 10 further comprises a device for cooling said generator 21. Said system 10 comprises a branch 37 configured to supply said cooling device with working fluid from the circuit 31-36 and to return said working fluid to said circuit 31-36, after cooling of said generator 21. Said working fluid is returned to said circuit 31-36 via a part of the branch with the reference 38 in FIG. 1.

Said cooling device is configured so as to cool said generator 21 by evaporation of said working fluid within said generator 21. It is to be noted that said working fluid enters said generator 21 in the liquid phase.

To indicate the relative positions of the elements included in the fluid circuit 31-36, there follows a description of the elements that it comprises and of the sections 31-36 which connect said elements.

Said circuit thus comprises a first section 31 through which the working fluid flows in the vapour state, at high temperature and high pressure. This section 31 conveys the working fluid to the turbine 22 in which it expands, driving the turbine in rotation, this rotation advantageously being transmitted to the generator 21 via a transmission shaft.

The working fluid leaves said turbine 22 and flows in a section 32 in the vapour state, at high temperature and low pressure. This section 32 conveys the fluid to a condenser 50 which serves to fully condense said fluid.

It is to be noted, by way of an option, that said fluid passes first through a regenerator 70 before being conveyed, via an intermediate section 33, to said condenser 50.

Once fully condensed, said working fluid flows from the condenser 50 to a pump 60, in particular via a section 34. Said working fluid is then in the liquid state, at low temperature and low pressure. After passing through said pump 60, the working fluid is still in the liquid state, at low temperature but high pressure.

It flows via a section 35 toward an evaporator 80 whence it emerges in gaseous form, at high temperature and high pressure, to then be sent to the turbine 22, in particular via the above-mentioned section 31.

In the event that said circuit 31-36 comprises a regenerator 70, said working fluid passes first through said regenerator 70 before being sent to said evaporator 80 via an intermediate section 36.

According to the embodiment shown here, it is the branch 37 that is configured to supply working fluid from said circuit 31-36 to the cooling device. However, it is to be noted that said cooling device can be supplied by bleeding at other points on the circuit 31-36, provided that the working fluid is in the liquid state and at a pressure which is slightly higher than that at the condenser 50. Indeed, the aim is to allow said working fluid, bled in this manner, to flow within said generator 21.

According to the same embodiment, it is the part of the branch 38 which returns said working fluid to said circuit 31-36, after cooling. According to the invention, cooling is effected by evaporation of said working fluid within said generator 21, whence the working fluid exits in the gaseous state, in the form of a vapour, and can be re-injected at any point on the circuit 31-36 where the fluid flows in the gaseous state, in particular at low pressure, as in this case upstream of said condenser 50, that is to say in section 32, or 33 if a regenerator 70 is present.

Any other configuration for bleeding the fluid in the liquid state is conceivable, as is any other configuration for returning this same fluid, in the gaseous state, to said circuit 31-36, without departing from the scope of the invention.

It should be noted that the working fluid designed to be evaporated in said cooling device is advantageously supplied to said generator 21 via a valve 40, referred to as the expansion valve 40. This expansion valve 40 is in this case positioned in the branch 37, which is in fact a bypass branch for part of the working fluid, between the outlet of the pump 60 and said generator 21. The working fluid designed to be evaporated in said cooling device can be injected into said generator 22 via a nozzle 41, referred to as the injection nozzle 41, which is shown in FIG. 2.

In the example shown, the condenser 50 makes it possible to remove heat that builds up within the generator 21. Thus, in addition to its function within the thermodynamic circuit 31-36, the condenser 50 controls the cooling of the generator 21.

It should also be noted that the pump 60 serves to raise the pressure of said working fluid in the liquid phase, and that it is advantageously positioned downstream of said condenser 50. In order to avoid any risk of said pump 60 cavitating, all of the fluid must pass from the gaseous state to the liquid state at the condenser 50, in particular at the pressure of the condenser 50. To that end, the condenser 50 is connected to a cooling circuit which comprises an appropriately dimensioned cold source 91, in particular taking into account the twin function of the condenser 50. Said cooling circuit is a circuit external to the circuit 31-36.

It should also be noted that the regenerator 70, which is optional, makes it possible to exchange heat energy between said working fluid when it is in the gas phase and said working fluid when it is in the liquid phase. Said regenerator 70 is in this case positioned downstream of the turbine 22 in a part of the circuit 31-36 that is configured for the working fluid to circulate in the gas phase, in particular between section 32 and the intermediate section 33, and downstream of said pump 60 in a part of the circuit 31-36 that is configured for the fluid to circulate in the liquid phase, in particular between section 35 and the intermediate section 36.

It should also be noted that the evaporator 80 is configured to evaporate the working fluid when it is in the liquid phase. Said evaporator 80 is positioned between said pump 60 and said turbine 22. To that end, the evaporator 80 is connected to a heating circuit which comprises a heat source 92. Said heating circuit is a circuit external to the circuit 31-36.

FIG. 2 shows an example of a cooling device which is configured to cool said generator 21. It should be noted that said generator 21 is advantageously an electromagnetic generator. It comprises a stator 24 and a rotor 23, which are in particular electromagnetic.

Said cooling device comprises a cavity 26 formed in a body that is designed to form part of said rotor 23, said cavity 26 being designed to receive the working fluid, in particular in the liquid state. Said device is designed to create a film of said working fluid in its liquid state, in said cavity 26, under the effect of a centrifugal force that exists when the rotor 23 is in rotation with respect to said stator 24.

Said device is further designed to allow said fluid to be evacuated in its gaseous state to outside the cavity 26, in particular via ducts 25 which are regularly distributed about an axis of longitudinal extent of the rotor 23, referred to as the axis of the rotor and provided with the reference X in FIG. 2. In particular, said cavity 26 comprises a pair of walls 28, 29 that are arranged so as to contain the film of fluid in the liquid state. In other words, said walls 28, 29 make it possible to retain a sheet of fluid in the liquid state, at the level of the rotor 23 of said generator 21. Said sheet of fluid is designed to be evaporated and it is the use of the enthalpy of the change of state of said fluid which makes it possible to cool said generator 21, in particular at said rotor 23.

The walls 28, 29 forming the cavity 26 are rims formed in the body of the rotor 23, protuberances of the material of said rotor, or cantilever-style elements on said rotor 23. It should be noted that any element which projects from the in particular smooth surface of the rotor 23, and by means of which it is possible to retain a film of fluid in the liquid state is included in the invention. Thus, the example illustrated and described here is non-limiting.

Furthermore, said walls 28, 29 are advantageously configured so as not to allow said portion of fluid to escape from said cavity 26 thus delimited by any way other than by evaporation or overflowing.

The rotor 23 comprises a body, forming a shaft 23′, which is above all represented by its useful portion. The “useful portion” is understood to be that portion which contributes to the generation of electrical current by the electromagnetic generator 21; in other words, that portion which bears an electromagnetic element 23″. That is also to say that the part of the shaft 23′ which bears the bearing mounts, which allow the rotor 23 to rotate, is only partially illustrated here.

The electromagnetic generator 21 comprises an electromagnetic element 23″ which is mounted on the shaft 23′ of the rotor 23. Said electromagnetic element 23″ can be a permanent magnet. In this case, said electromagnetic element 23″ is an electromagnetic winding. It can take any other form, such as a cage rotor, without departing from the scope of the invention.

Furthermore, as shown in FIG. 2, the cavity 26 is in this case positioned between the electromagnetic winding 23″ and the shaft 23′. It should be noted that said shaft 23′ has a main direction of longitudinal extent, termed the main axis, which is given the reference X in FIG. 2.

In that respect, said cavity 26 extends longitudinally along the electromagnetic winding 23″, in the direction of said main axis X. More precisely, one side 26′ of said cavity 26 is in contact with at least one part of said electromagnetic winding 23″. However, the cavity 26 does not in this case consist only of the region provided with the side 26′ in contact with the electromagnetic winding 23″, since it also comprises the pair of said walls 28, 29 arranged laterally.

The walls 28, 29 forming the cavity 26 are rims formed in said shift 23′, protuberances of the material of said shaft 23′, or cantilever-style elements on said shalf 23′. It should be noted that any element which projects from the in particular smooth—surface of the shaft 23′, and by means of which it is possible to retain a film of fluid in the liquid state is included in the invention. Thus, the example illustrated and described here is non-limiting.

In other words, the walls 28, 29 are advantageously configured so as to allow a portion of fluid in the liquid state to reside in the cavity 26 that they delimit, in particular under the effect of the centrifugal force experienced by the rotating portion of the electromagnetic generator 21. Said walls 28, 29 are advantageously configured so as not to allow said portion of fluid to escape from said cavity 26 thus delimited by any way other than by evaporation.

Here, the cavity 26 is formed by the region provided with the side 26′ in contact with the electromagnetic winding 23″, but also by another region located at a block 43 for admitting the liquid into said cavity 26.

Said admission block 43 comprises a means for injecting said fluid in the liquid state, hereinafter termed input pipe 41. This input pipe 41 is fixed with respect to the stator 24, in particular with respect to the casing 24′″ of said stator 24; it is a tube for supplying liquid to the cavity 26. The admission block 43 thus consists of a part that is fixed with respect to the stator 24—said input pipe 41—and a part that is fixed with respect to the rotor 23. Said part that is fixed with respect to the rotor 23 is an annular ring secured to the rotor 23 and identified by 42 in the figure. Said annular ring 42 is to be made of a material that is impermeable to liquids; it is this annular ring 42 which, here, forms one of said walls 28 of the cavity 26.

Thus, the cavity 26 is designed to receive a fluid in the liquid state.

As shown in FIG. 2, the cooling device is designed to create a film of said fluid, in said cavity 26, in particular at the region provided with said side 26′, in particular under the effect of a centrifugal force that exists when the rotor 23 rotates with respect to the stator 24. Said device further comprises one or more ducts 25 for discharging said fluid from the cavity 26, said fluid being discharged via the duct(s) 25 in the gaseous state.

Opposite said discharge ducts 25, the cooling device comprises one or more inlet ducts 25′ for fluid in the liquid state, between said admission block 43 and that portion of the cavity 26 which is formed within the shaft 23′, specifically the region provided with the side 26′ that is in contact with the electromagnetic winding 23″.

These inlet ducts 25′ for fluid in the liquid state are in this case considered to belong to the cavity 26 since they are located between the two walls 28, 29. Said fluid inlet and discharge ducts 25′, 25 are for example distributed angularly about the main axis X.

The film of fluid created in the cavity 26, as shown in FIG. 2, helps to absorb the heat produced by the rotation of the rotor 23 within the stator 24. Indeed, evaporation of this fluid makes it possible to cool said generator, in particular at the moving part 23 of said generator 21. Furthermore, the small depth of fluid in the liquid state, due to its configuration as a film, makes it easier for it to rise in temperature and thus to reach its evaporation point.

The film of fluid in the liquid state remains immobile, or stagnant, inside the cavity 26. Said region provided with the side 26′ is configured such that said film has a free surface at which the fluid evaporates.

The evaporated fluid is discharged via the discharge ducts 25 which are gas discharge ducts (see arrows 25″ in FIG. 2).

It should be noted that said discharge ducts 25 are provided closer to the main axis X than the inlet ducts 25′.

It should also be noted that the density of the evaporated fluid is approximately 100 times less than that of the same fluid in the liquid state. This advantageously supports the mechanical discharge of the evaporated fluid, without external assistance, merely by means of a simple difference in pressure, that is to say without any internal means designed to circulate said fluid.

It should further be noted that the heat absorbed by this evaporation is greater than the heat that would be absorbed by heating of a gas flowing at the same location. This also means that the flow rate of liquid fluid at the admission block 43 can be low, which helps to increase the overall efficiency of the electromagnetic generator 21.

Thus, the input pipe 41 is a liquid inlet tube which is not overlarge.

Furthermore, it is not necessary to provide a pump to bring fluid in the liquid state into said input pipe because the flow rate to be delivered to the cavity 26 is low.

Moreover, the injection of liquid fluid by the input pipe 41 may advantageously be subordinate, for example, to an overflow sensor located at liquid purges positioned close to the bearings (details not shown here).

Thus, the device of the invention proposes cooling the electromagnetic generator 21 using a simple arrangement, in particular an arrangement of inlet ducts 25′ and outlet ducts 25 for a fluid, said ducts being borne by the rotor 23 of said generator 21.

It should be noted that the cooling device should advantageously comprise a ring 27 which is positioned on the side of said input pipe 41, said ring 27 being configured to prevent any escape of gas. Thus, said ring 27 prevents any gas leaks on the side of the admission block 43, in particular in the event of gas leaking through the inlet duct 25′ for fluid in the liquid state.

In addition, it should be noted that the admission block 43 is advantageously on the opposite side of said cavity 26 from the discharge duct 25 of the cooling device, along said main axis X.

The evaporation of said fluid helps to cool said generator. Furthermore, the fluid is easily discharged once evaporated. Said cooling device therefore has the advantage of being particularly effective since it is based on cooling by change of phase, and is also simple in terms of structure.

It should be noted that the system 10 according to the invention advantageously comprises a sealing device (not shown here) that is arranged so as to ensure a seal between said turbine 22 and said generator 21. Said sealing device is positioned between said turbine 22 and said generator 21; it comprises, in particular, a packing seal that is configured to prevent said working fluid, when in the gas phase, from flowing from said turbine 22 to said generator 21.

In this case, the point of extraction, toward the condenser 50, of the working fluid in the vapour state, at high temperature and low pressure, is between the turbine 22 and the generator 21.

It should also be noted that the generator 21 should also comprise a circuit that is configured for cooling the stator 24 by circulation of fluid, said fluid entering said cooling circuit in the liquid state (inlet denoted 24′ in FIG. 2) and leaving in the gaseous state (outlet 24″ in FIG. 2). The inlet 24′ and the outlet 24″ are created directly in the casing 24″' of the stator 24.

It should also be noted that the fluid used to cool the electromagnetic generator 21 —at the rotor 23 and/or at the stator 24—is the same working fluid which flows within the system 10 according to the invention.

It should also be noted that variant embodiments are of course possible. As already stated, it is also conceivable, in an exemplary embodiment which is not shown here, for the liquid working fluid, which is to be supplied to the device for cooling the generator 21, to be bled at other points on the circuit 31-36, as is the case for its return to the gaseous state in said circuit 31-36. That is even more recommended for circuits 31-36 which implement the Rankine cycle and in which the constituent elements differ from those described here, or are arranged differently with respect to one another.

Nonetheless, liquid working fluid must always be bled from a part of the circuit in which the fluid flows in the liquid state, at low temperature and at relatively high pressure, whereas said gaseous fluid must be re-injected into the circuit at a point at which said fluid flows in the gaseous state, and preferably at low pressure.

Thus, the system 10 of the invention requires a low flow rate of liquid in order to cool the generator 21 of the circuit 31-36 which it comprises, in particular when this flow rate is compared to that which is usually used by a circuit for cooling by heating of the liquid even when this liquid is the same as a working liquid of the thermodynamic system in which it is positioned.

It should also be noted that still other variant embodiments are possible. In particular, it is also conceivable, in an exemplary embodiment which is not shown here, for the rotor to rotate around the stator, without departing from the scope of the invention.

It is also conceivable, in exemplary embodiments which are not shown here, for the rotor 23 to be driven by any motive force provided by transformation of solar energy, wind energy, wave or tidal energy, or even nuclear energy, that provides a motive torque, either directly or via the intermediary of a turbine.

1. A thermodynamic system, in particular a system implementing a Rankine cycle, comprising a circuit for circulation of a working fluid, said circuit comprising an energy production means, said system further comprising a device for cooling said energy production means and a branch configured to supply said cooling device with working fluid from said circuit and to return said working fluid to said circuit, said cooling device being configured so as to cool said energy production means by evaporation of said working fluid within said production means, said working fluid entering said energy production means in the liquid phase, said energy production means comprising a turbine that forms part of said circuit, and an electrical energy generator coupled to said turbine, said turbine being designed to be driven by the expansion of said working fluid in the gas phase, said cooling device being configured to cool said generator, said generator being an electromagnetic generator comprising a stator and a rotor, said cooling device comprising a cavity formed in a body that is designed to form part of said rotor, said cavity being designed to receive the working fluid, said device being designed to create a film of said working fluid in its liquid state, in said cavity, under the effect of a centrifugal force that exists when the rotor is in rotation with respect to said stator, said device being further designed to allow said fluid to be evacuated in its gaseous state to outside the cavity.

2. The system as claimed claim 1, in which the working fluid designed to be evaporated in said cooling device is introduced into said energy production means via a valve termed the expansion valve.

3. The system as claimed in either one of claim 1, in which the working fluid designed to be evaporated in said cooling device is injected into the energy production means via a nozzle termed the injection nozzle.

4. The system as claimed in claim 1, in which said circuit further comprises a condenser, said condenser being configured to condense the working fluid when it is in the gas phase.

5. The system as claimed in claim 1, in which said circuit further comprises a pump, said pump serving to raise the pressure of said working fluid when it is in the liquid phase, said pump being positioned downstream of said condenser.

6. The system as claimed in claim 1, in which the working fluid designed to be evaporated in the cooling device is bled from the circuit downstream of said pump. cm 7. The system as claimed in claim 5, in which said circuit further comprises a regenerator, said regenerator being configured to exchange heat energy between said working fluid when it is in the gas phase and said working fluid when it is in the liquid phase, said regenerator being positioned downstream of said turbine in a part of the circuit that is configured for the working fluid to circulate in the gas phase, and downstream of said pump in a part of the circuit that is configured for the fluid to circulate in the liquid phase.

8. The system as claimed in claim 5, in which said circuit further comprises an evaporator, said evaporator being configured to evaporate the working fluid when it is in the liquid phase, said evaporator being positioned between said pump and said turbine.

9. The system as claimed in claim 4, in which the working fluid evaporated inside said energy production means by said cooling device is released into the circuit upstream of said condenser.

10. The system as claimed claim 1, further comprising a sealing device that is arranged so as to ensure a seal between said turbine and said generator, said sealing device being positioned between said turbine and said generator.

11. The system as claimed in claim 10, in which said sealing device comprises a packing seal that is configured to prevent said working fluid, when in the gas phase, from flowing from said turbine to said generator.

12. The system claimed in claim 1, in which said cavity comprises a pair of walls that are arranged so as to contain the film of fluid in the liquid state.

13. The system as claimed in claim 1, in which said cooling device comprises a means for injecting said fluid in the liquid state at the level of said cavity and a discharge duct, said means for injecting said fluid in the liquid state at the level of said cavity being on the opposite side of said cavity from the discharge duct.

14. The system as claimed in claim 1, in which the rotor comprises a shaft which is formed from said body and on which is mounted an electromagnetic element, said shaft having a main direction of longitudinal extent, termed the main axis, the electromagnetic element being an electromagnetic winding, the cavity of the cooling device being positioned between said electromagnetic winding and said shaft.

15. The system as claimed in claim 1, in which said cavity extends longitudinally along said electromagnetic winding, in the direction of said main axis, with one side of said cavity being in contact with at least one part of said electromagnetic winding.
